(19) United States
(12) Patent Application Publication
(10) Pub. No.: US 2010/0103816 A1
(43) Pub. Date: Apr. 29, 2010

(54) TRANSMISSION APPARATUS, TRANSMISSION SYSTEM AND TRANSMISSION METHOD

(75) Inventor: Masanori EIRO, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/502,508

(22) Filed: Jul. 14, 2009

(30) Foreign Application Priority Data
Oct. 28, 2008 (JP) 2008-277339

(51) Int. Cl. H04L 12/24

(52) U.S. Cl. 370/230

(57) ABSTRACT

A transmission apparatus that receives data from a first external apparatus via a first network, and transmits the received data to a second external apparatus via a second network, the transmission apparatus includes a receiving unit that receives data from the first external apparatus, a storage unit that stores the data received by the receiving unit, a transmission unit that reads out the data stored in the storage unit and transmits the data to the second external apparatus at a predetermined transmission speed, a transmission-pause-time calculation unit that calculates the time that is needed to reduce an amount of data stored in the storage unit from a first threshold value to a second threshold value as a transmission-pause-time, and a pause-request-frame transmission unit that adds the transmission-pause-time to the pause request frame and transmits the pause request frame to the first external apparatus.

### CROSS-REFERENCE TO RELATED APPLICATION(S)

This application is based upon and claims the benefit of priority from Japanese Patent Application No. 2008-277339, filed on Oct. 28, 2008, the entire contents of which are incorporated herein by reference.

### FIELD

The embodiments discussed herein are directed to a transmission apparatus, transmission system, and transmission method.

### BACKGROUND

Some conventionally-known transmission apparatuses receive data such as an Ethernet frame from an external apparatus via an Ethernet® line to map the data on a SONET (Synchronous Optical Network) frame, and transmit the resulting data to other external apparatus via a SONET transmission line. Such transmission apparatuses are widely used. Meanwhile, data transmission capacity of the Ethernet line sometimes differs from that of the SONET transmission line. If the amount of data that is input to the transmission apparatus via the Ethernet line exceeds the amount of data that is output from the transmission apparatus via the SONET transmission line, there may occur a situation in which the transmission apparatus cannot output the data received from the external apparatus via the Ethernet line to another external apparatus via the SONET transmission line. In other words, the transmission apparatus falls into a congestion state, and disposal of the received data occurs in the transmission apparatus.

To avoid such a situation from occurring, a transmission apparatus described in Japanese Patent No. 3997513 and Japanese Laid-open Patent Publication No. 2002-368803 includes a buffer that temporarily stores data that is received from an external apparatus via an Ethernet line. When the amount of stored data reaches the buffer capacity, the transmission apparatus transmits a pause frame (pause-request frame) to the external apparatus that transmits the data. In the pause frame, the transmission apparatus requests the external apparatus to stop the transmission of data. On receiving the pause frame, the external apparatus stops the transmission of data to the transmission apparatus. As a result, the amount of data in the buffer of the transmission apparatus decreases, and the state of congestion is resolved.

FIG. 7 is a block diagram that illustrates a configuration of a transmission system 100 provided with a conventional transmission apparatus. As illustrated in FIG. 7, the transmission system 100 includes a transmission apparatus 101 and a first external apparatus 102. The transmission apparatus 101 receives data from the first external apparatus 102 via an Ethernet line which is a first network, and transmits the received data to a second external apparatus 103 via a SONET transmission line which is a second network.

Firstly, configuration of the transmission apparatus 101 is explained. The transmission apparatus 101 includes a data receiving unit 110, an RX buffer unit 112, a SONET frame mapping unit (hereinafter abbreviated as “SFM unit”) 114, a SONET frame demapping unit (hereinafter abbreviated as “SFDM unit”) 116, a TX buffer unit 118, and a data transmission unit 120.

The data receiving unit 110 is a receiver that receives data such as an Ethernet frame from the first external apparatus 102, and includes an RXPHY unit 110a, and an RXMAC unit 110b. The RXPHY unit 110a descrambles the data received from the first external apparatus 102. The RXMAC unit 110b conducts a MAC (media access control) process on data output from the RXPHY unit 110a, and outputs the resulting data to the RX buffer unit 112.

The RX buffer unit 112 stores the data received by the data receiving unit 110. A pause-frame-transmission-start threshold value 112a and a data-transmission-restart threshold value 112b are set in the RX buffer unit 112. The data-transmission-restart threshold value 112b is smaller than the pause-frame-transmission-start threshold value 112a. The pause-frame-transmission-start threshold value 112a is a threshold value to which a pause-request controller 122 (described later) refers when the pause-request controller 122 instructs a pause-frame generator 120c (described later) to generate the pause frame to which a predetermined transmission-pause-time is added. The pause-frame generator 120c is included in the data transmission unit 120. The data-transmission-restart threshold value 112b is a threshold value to which the pause-request controller 122 refers when the pause-request controller 122 instructs the pause frame generator 120c to generate the pause frame to which the transmission-pause-time, “0” value is added. The transmission-pause-time is a period of time that the first external apparatus 102 stops transmitting the data to the transmission apparatus 101 upon receiving the pause frame from the transmission apparatus 101.

The SFM unit 114 reads out the data stored in the RX buffer unit 112, and functions as a transmitter that transmits the data to the second external apparatus 103 at a predetermined transmission speed. The SFM unit 114 performs multiple mapping of the data read out from the RX buffer unit 112 on a predetermined SONET frame, and transmits the resulting SONET frame to the second external apparatus 103.

When the SFDM unit 116 receives data, such as the SONET frame on which the multiple mapping of the Ethernet frame is performed, from the second external apparatus 103, the SFDM unit 116 demaps the data and outputs the resulting data to the TX buffer unit 118.

The TX buffer unit 118 temporarily stores the data output from the SFDM unit 116.

The data transmission unit 120 includes a TXMAC unit 120a, and a TXPHY unit 120b. The TXMAC unit 120a reads out the data stored in the TX buffer unit 118, and performs MAC process on the data. The TXPHY unit 120b scrambles the data output from the TX buffer unit 118 and transmits the scrambled data to the first external apparatus 102.

The TXMAC unit 120a includes the pause-frame generator 120c and a pause-frame transmitter 120d. The pause-frame generator 120c generates the pause frame in accordance with the instruction of the pause-request controller 122. The pause-frame transmitter 120d transmits the pause frame generated by the pause-frame generator 120c to the first external apparatus 102 via the TXPHY unit 120b.

The pause-request controller 122 monitors the amount of data stored in the RX buffer unit 112. If the amount of data reaches the pause-frame-transmission-start threshold value 112a, the pause-request controller 122 instructs the pause-frame generator 120c to generate the pause frame to which the predetermined transmission-pause-time is added. When the amount of data stored in the RX buffer unit 112 decreases from the pause-frame-transmission-start threshold value 112a to the data-transmission-restart threshold value 112b, the pause-request controller 122 instructs the pause-frame generator 120c to generate the pause frame to which the transmission-pause-time “0” value is added.

A data transmission method for resolving a congestion occurred in the transmission apparatus 101 in the transmission system 100 with the above-described configuration is explained below with reference to FIGS. 8A to 8E. FIGS. 8A to 8E are drawings to explain a data transmission method of the conventional transmission system 100. In the explanation below, it is assumed that the amount of data input to the transmission apparatus 101 via the Ethernet line exceeds the amount of data output from the transmission apparatus 101 via the SONET transmission line.

As illustrated in FIG. 8A, if the amount of data input to the transmission apparatus 101 via the Ethernet line exceeds the amount of data output from the transmission apparatus 101 via the SONET transmission line, the transmission apparatus 101 cannot efficiently output the Ethernet frame, which is received from the first external apparatus 102, to the SONET transmission line. Specifically, the amount of data stored in the RX buffer unit 112 illustrated in FIG. 7 increases and reaches the pause-frame-transmission-start threshold value 112a. As a result, congestion A occurs in the transmission apparatus 101.

When the amount of data stored in the RX buffer unit 112 reaches the pause-frame-transmission-start threshold value 112a, as illustrated in FIG. 8B, the transmission apparatus 101 transmits the pause frame, to which the predetermined transmission-pause-time is added, to the first external apparatus 102. Specifically, in the transmission apparatus 101, in accordance with the instruction of the pause-request controller 122, the pause-frame generator 120c generates the pause frame to which the predetermined transmission-pause-time is added. Then, the pause-frame transmitter 120d transmits the pause frame to the first external apparatus 102. The first external apparatus 102, which receives the pause frame, sets a predetermined transmission-pause-time to a timer value, and stops transmitting the Ethernet frame to the transmission apparatus 101.

Subsequently, as illustrated in FIG. 8C, the transmission apparatus 101 transmits the SONET frame to the second external apparatus 103 at a predetermined transmission speed. Specifically, in the transmission apparatus 101, the SFM unit 114 reads out the data stored in the RX buffer unit 112, and transmits the data to the second external apparatus 103 at a predetermined transmission speed. Thus, the amount of data stored in the RX buffer unit 112 is reduced, and the congestion A is gradually resolved.

As illustrated in FIG. 8D, when the amount of data stored in the RX buffer unit 112 is reduced, and the congestion A is completely resolved, the transmission apparatus 101 transmits the pause frame, to which the transmission-pause-time “0” value is added, to the first external apparatus 102. Specifically, in the transmission apparatus 101, when the amount of data stored in the RX buffer unit 112 is reduced to the data-transmission-restart threshold value 112b, in accordance with the instruction of the pause-request controller 122, the pause-frame generator 120c generates the pause frame to which the transmission-pause-time “0” value is added. Then the pause-frame transmitter 120d transmits the pause frame to the first external apparatus 102.

Then, as illustrated in FIG. 8E, the first external apparatus 102, which receives the pause frame, sets the transmission-pause-time “0” value to the timer value, and restarts transmitting the Ethernet frame to the transmission apparatus 101.

However, in the conventional data transmission method, during the process of resolving the congestion A which occurs in the transmission apparatus 101, it is necessary to transmit the pause frames twice from the transmission apparatus 101 to the first external apparatus 102. Specifically, the transmission apparatus 101 transmits the pause frame (pause frame to which a predetermined transmission-pause-time is added) to the first external apparatus 102 for stopping the transmission of data to the transmission apparatus 101. In addition, the transmission apparatus 101 transmits the pause frame (pause frame to which the transmission-pause-time “0” value is added) to the first external apparatus 102 for resuming the transmission of data to the transmission apparatus 101.

If the transmission apparatus 101 transmits the pause frame twice to the first external apparatus 102, load of the transmission apparatus 101 for transmitting the data to the first external apparatus 102 increases. Specifically, as illustrated in FIG. 9, if the pause frame is transmitted twice from the transmission apparatus 101 to the first external apparatus 102, the Ethernet frame, which is to be transmitted, stagnates in the transmission apparatus 101. Thus, the data transmission speed in the leftward direction in FIG. 9 decreases. Therefore, the amount of data stored in the TX buffer unit 118 illustrated in FIG. 7 increases and exceeds the capacity limit of the TX buffer unit 118. As a result, a new congestion B occurs in the TX buffer unit 118, in addition to the congestion A in the RX buffer unit 112.

### SUMMARY

According to an aspect of the invention, a transmission apparatus is configured to receive data from a first external apparatus via a first network, and transmit the received data to a second external apparatus via a second network, and the transmission apparatus includes: a receiving unit that receives data from the first external apparatus; a storage unit that stores the data received by the receiving unit; a transmission unit that reads out the data stored in the storage unit and transmits the data to the second external apparatus at a predetermined transmission speed; a pause-request-frame generating unit that generates the pause request frame that causes transmission of data from the first external unit to stop when an amount of data stored in the storage unit reaches a first threshold value; a transmission-pause-time calculation unit that calculates transmission-pause-time during which the transmission of data from the first external apparatus is stopped, the transmission-pause-time being time during which the transmission unit transmits the data stored in the storage unit to the second external apparatus at the predetermined transmission speed until the amount of data stored in the storage unit is decreased from the first threshold value to a second threshold value which is smaller than the first threshold value; and a pause-request-frame transmission unit that adds the transmission-pause-time calculated by the transmission-pause-time calculation unit to the pause request frame, and transmits the pause request frame to the first external apparatus.

According to another aspect of the invention, a transmission system includes a first external apparatus and a transmission apparatus. The transmission apparatus is configured to receive data from the first external apparatus via a first network, and transmit the received data to a second external apparatus via a second network. The transmission apparatus includes a receiving unit that receives data from the first external apparatus, a storage unit that stores the data received by the receiving unit, a transmission unit that reads out the data stored in the storage unit and transmits the data to the second external apparatus at a predetermined transmission speed, a pause-request-frame generating unit that generates a pause request frame that causes transmission of data from the first external apparatus to stop when an amount of data stored in the storage unit reaches a first threshold value, a transmission-pause-time calculation unit that calculates transmission-pause-time during which the transmission of data from the first external apparatus is stopped, the transmission-pause-time being time during which the transmission unit transmits the data stored in the storage unit to the second external apparatus at the predetermined transmission speed until the amount of data stored in the storage unit is decreased from the first threshold value to a second threshold value which is smaller than the first threshold value, and a pause-request-frame transmission unit that adds the transmission-pause-time calculated by the transmission-pause-time calculation unit to the pause request frame, and transmits the pause request frame to the first external apparatus. The first external apparatus includes a transmission stopping unit that stops transmission of data to the transmission apparatus upon receiving the pause request frame transmitted from the transmission apparatus, and a transmission starting unit that starts transmission of data to the transmission apparatus when the transmission-pause-time, which is added to the pause request frame, elapses.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWING(S)

FIG. 1 is a block diagram of configuration of a transmission system according to a first embodiment;

FIG. 2 is a flowchart that illustrates the process procedure of a data transmission process in the transmission apparatus according to the first embodiment;

FIG. 3 is a block diagram that illustrates configuration of a transmission system according to a second embodiment;

FIG. 4 is an example of a corresponding table illustrated in FIG. 3;

FIG. 5 is another example of the corresponding table illustrated in FIG. 3;

FIG. 6 is a flowchart that illustrates the process procedure of a data transmission process according to the second embodiment;

FIG. 7 is a block diagram that illustrates a configuration of a conventional transmission system;

FIGS. 8A to 8E are drawings to explain a data transmission method of the conventional transmission system; and

FIG. 9 is a drawing to explain a congestion that occurs in a transmission apparatus during data transmission to a first external apparatus in the conventional transmission system.

### DESCRIPTION OF EMBODIMENT(S)

Preferred embodiments of a transmission apparatus, transmission system, and transmission method of the invention are explained in detail below with reference to the accompanying drawings. In the description below, it is assumed that a first network that connects a first external apparatus with a transmission apparatus is an Ethernet line, and a second network that connects the transmission apparatus with a second external apparatus is a SONET transmission line. However, the present invention is not limited to the above; various types of other networks may be adopted as the first network and the second network.

### [a] First Embodiment

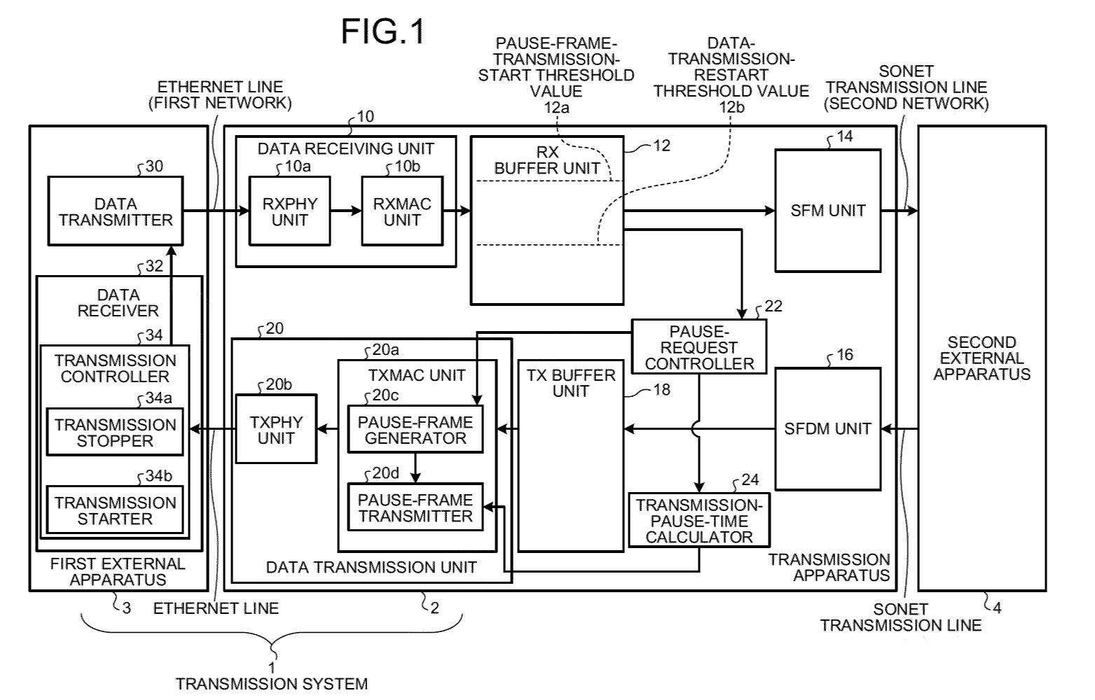

Referring to FIG. 1, a configuration of a transmission system 1 according to a first embodiment is explained. FIG. 1 is a block diagram of the configuration of the transmission system 1 according to the first embodiment. As illustrated in FIG. 1, the transmission system 1 includes a transmission apparatus 2 and a first external apparatus 3. The transmission apparatus 2 receives data from the first external apparatus 3 via an Ethernet line which is a first network, and transmits the received data to a second external apparatus 4 via a SONET transmission line which is a second network. The configuration of the transmission apparatus 2 is explained first, and then the configuration of the first external apparatus 3 is explained.

The transmission apparatus 2 includes a data receiving unit 10, an RX buffer unit 12, a SONET frame mapping unit (hereinafter abbreviated as “SFM unit”) 14, a SONET frame demapping unit (hereinafter abbreviated as “SFDM unit”) 16, a TX buffer unit 18, a data transmission unit 20, and a transmission-pause-time calculator 24.

The data receiving unit 10 is a receiver that receives data such as an Ethernet frame from the first external apparatus 3, and includes an RXPHY unit 10a and an RXMAC unit 10b. The RXPHY unit 10a descrambles the data received from the first external apparatus 3. The RXMAC unit 10b conducts an MAC (media access control) process on data that is output from the RXPHY unit 10a and outputs the resulting data to the RX buffer unit 12.

The RX buffer unit 12 is a storage that stores the data received by the data receiving unit 10. A pause-frame-transmission-start threshold value 12a and a data-transmission-restart threshold value 12b are set in the RX buffer unit 12. The data-transmission-restart threshold value 12b is smaller than the pause-frame-transmission-start threshold value 12a. The pause-frame-transmission-start threshold value 12a is a threshold value to which a pause-request controller 22 refers when the pause-request controller 22 instructs a pause-frame generator 20c to generate the pause frame. The pause-frame generator 20c is included in the data transmission unit 20 and is described later. The transmission-pause-time is a period of time during which the first external apparatus 3 stops transmitting data to the transmission apparatus 2 upon receiving the pause frame from the transmission apparatus 2.

The SFM unit 14 reads out the data stored in the RX buffer unit 12, and functions as a transmitter that transmits data to the second external apparatus 4 at a predetermined transmission speed. The SFM unit 14 performs multiple mapping of the data read out from the RX buffer unit 12 on a predetermined SONET frame, and transmits the resulting SONET frame to the second external apparatus 4 at a predetermined transmission speed.

According to the first embodiment, as the target SONET frame on which the SFM unit 14 performs multiple mapping of data, STS1-XV (X-1, 2, 3, . . . ), or STS3C-YV (Y=1, 2, 3, . . . ) are adopted. Meanwhile, STS1-XV means a channel group that is virtually concatenated (VCAT: Virtual Concatenation) with X-pieces of STS (Synchronous transport signal) 1, and STS3C-YV means a channel group that is virtually concatenated with Y-pieces of STS3C.

STS1 and STS3C respectively have different predetermined transmission speed (i.e., data rate). The transmission speed of a channel group including virtually concatenated n-pieces of channels is n-fold of transmission speed of one channel when the channels have the same transmission speed. For example, because the data rate of STS1-1V is 48.384 Mbps, the data rate of STS1-2V is 48.384 Mbps×2=96.768 Mbps, and the data rate of STS1-3V is 48.384 Mbps×3=145.152 Mbps. Thus, the transmission speed of data that is transmitted to the second external apparatus 4 by the SFM unit 14 is different depending on the types of the SONET frames on which the data is mapped. In other words, the data transmission speed is different depending on STS1-XV (X-1, 2, 3, . . . ), or STS3C-YV (Y=1, 2, 3, . . . ).

When the SFDM unit 16 receives data such as the SONET frame, on which multiple mapping of the Ethernet frame is performed, from the second external apparatus 4, the SFDM unit 16 demaps the data and outputs the resulting data to the TX buffer unit 18.

The TX buffer unit 18 temporarily stores the data output from the SFDM unit 16.

The data transmission unit 20 includes a TXMAC unit 20a, and a TXPHY unit 20b. The TXMAC unit 20a reads out the data stored in the TX buffer unit 18, and performs MAC process on the data. The TXPHY unit 20b scrambles the data output from the TX buffer unit 18 and transmits the scrambled data to the first external apparatus 3 as the Ethernet frame.

The TXMAC unit 20a includes the pause-frame generator 20c, and a pause-frame transmitter 20d. The pause-frame generator 20c generates the pause frame in accordance with an instruction of the pause-request controller 22. The pause-frame transmitter 20d adds the transmission-pause-time, which is calculated by the transmission-pause-time calculator 24, to the pause frame. Then the pause-frame transmitter 20d transmits the pause frame, to which the transmission-pause-time is added, to the first external apparatus 3 via the TXPHY unit 20b. Specific procedures for calculating the transmission-pause-time by the transmission-pause-time calculator 24 are explained in detail later.

The pause-request controller 22 monitors the amount of data stored in the RX buffer unit 12. If the amount of data reaches the pause-frame-transmission-start threshold value 12a, the pause-request controller 22 instructs the pause-frame generator 20c to generate pause frame. The pause-request controller 22 instructs the transmission-pause-time calculator 24 to calculate the transmission-pause-time, which is a period of time during which the transmission of data from the first external apparatus 3 stops.

The transmission-pause-time calculator 24 calculates the transmission-pause-time in accordance with the instruction of the pause-request controller 22. The SFM unit 14 transmits the data stored in the RX buffer unit 12 to the second external apparatus 4, at a predetermined transmission speed, until the amount of data stored in the RX buffer unit 12 is reduced from the pause-frame-transmission-start threshold value 12a to the data-transmission-restart threshold value 12b. As the transmission-pause-time, the transmission-pause-time calculator 24 calculates the time needed for reducing the amount of data from the pause-frame-transmission-start threshold value 12a to the data-transmission-restart threshold value 12b. More specifically, the transmission-pause-time calculator 24 calculates the transmission-pause-time by dividing the amount of data stored in the RX buffer unit 12 by the data transmission speed of the SFM unit 14. The amount of data stored in the RX buffer unit 12 is within the range from the pause-frame-transmission-start threshold value 12a to the data-transmission-restart threshold value 12b.

The specific procedure for calculating the transmission-pause-time by the transmission-pause-time calculator 24 is explained below. As described above, the data transmission speed of the SFM unit 14 differs depending on types of the SONET frames on which the data is mapped. In other words, the data transmission speed of the SFM unit 14 differs for each of STS1-XV (X-1, 2, 3, . . . ), and STS3C-YV (Y=1, 2, 3, . . . ). Accordingly, the transmission-pause-time calculated by the transmission-pause-time calculator 24 is different depending on the data transmission speed of the SFM unit 14.

For example, the data that is read out from the RX buffer unit 12 by the SFM unit 14, is mapped on STS3C-2V. Data transmission speed of STS3C-2V is 299.5 Mbps. Given that the amount of data stored in the RX buffer unit 12 in the range from the pause-frame-transmission-start threshold value 12a to the data-transmission-restart threshold value 12b is 8 Kbyte (64 Kbit), the transmission-pause-time is calculated as 64 Kbit/299.5 Mbps=214 μs. Meanwhile, let us presume the data that is read out from the RX buffer unit 12 by the SFM unit 14 is mapped on STS1-5V. Data transmission speed of STS1-5V is 241.92 Mbps. Given that the amount of data stored in the RX buffer unit 12 in the range from the pause-frame-transmission-start threshold value 12a to the data-transmission-restart threshold value 12b is 8 Kbyte (64 Kbit), the transmission-pause-time is calculated as 64 Kbit/241.92 Mbps=265 μs.

The transmission-pause-time calculator 24 outputs the calculated transmission-pause-time to the pause-frame transmitter 20d. The pause-frame transmitter 20d transmits the pause frame, to which the calculated transmission-pause-time is added, to the first external apparatus 3. As described above, the transmission-pause-time is a minimum time required to reduce the amount of data stored in the RX buffer unit 12 from the pause-frame-transmission-start threshold value 12a to the data-transmission-restart threshold value 12b, by the data transmission through the SFM unit 14. Therefore, according to the transmission apparatus 2 of the first embodiment, unlike the conventional transmission apparatus, there is no need to transmit the pause frame for restarting the data transmission to the first external apparatus 3. As a result, it is sufficient for the transmission apparatus 2 to transmit the pause frame to the first external apparatus 3 only once.

The configuration of the first external apparatus 3 is explained. The first external apparatus 3 includes a data transmitter 30, and a data receiver 32. The data transmitter 30 transmits data such as the Ethernet frame to the transmission apparatus 2 via the Ethernet line. The data receiver 32 receives data such as the Ethernet frame from the transmission apparatus 2 via the Ethernet line. The data receiver 32 includes a transmission controller 34. The transmission controller 34 includes a transmission stopper 34a and a transmission starter 34b.

Upon receiving the pause frame that is transmitted from the transmission apparatus 2, the transmission stopper 34a stops the transmission of data to the transmission apparatus 2. Specifically, upon receiving the pause frame from the transmission apparatus 2, the transmission stopper 34a instructs the data transmitter 30 to stop transmitting the data and makes the data transmitter 30 stop transmitting the data.

The transmission starter 34b extracts the transmission-pause-time from the pause frame received by the transmission stopper 34a. The transmission starter 34b starts transmitting data to the transmission apparatus 2 when the extracted transmission-pause-time elapses. Specifically, when the transmission-pause-time elapses, the transmission starter 34b instructs the data transmitter 30 to restart transmitting the data and makes the data transmitter 30 restart transmitting the data.

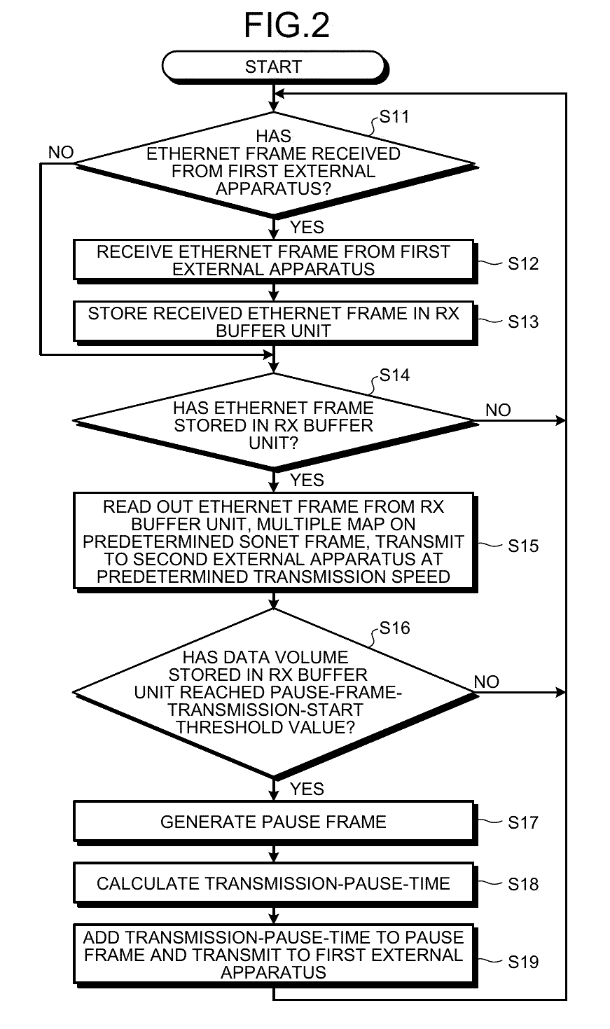

A process procedure of the data transmission process in the transmission apparatus 2 according to the first embodiment is explained. FIG. 2 is a flowchart that illustrates the process procedure of the data transmission process in the transmission apparatus 2 according to the first embodiment.

As illustrated in FIG. 2, in the transmission apparatus 2, the pause-request controller 22 determines whether the pause-request controller 22 has received the Ethernet frame from the first external apparatus 3 (Step S11). If the pause-request controller 22 determines that the pause-request controller 22 has received the Ethernet frame from the first external apparatus 3 (Step S11: Yes), the pause-request controller 22 proceeds to the process in Step S12. Meanwhile, if the pause-request controller 22 determines that the pause-request controller 22 has not received the Ethernet frame from the first external apparatus 3 (Step S11: No), the pause-request controller 22 proceeds to the process in Step S14.

At Step S12, the data receiving unit 10 receives the Ethernet frame from the first external apparatus 3 (Step S12). Then the RX buffer unit 12 stores the Ethernet frame, which is received by the data receiving unit 10 (Step S13).

At Step S14, the pause-request controller 22 determines whether the Ethernet frame is stored in the RX buffer unit 12 (Step S14). If the pause-request controller 22 determines that the Ethernet frame is stored in the RX buffer unit 12 (Step S14: Yes), the pause-request controller 22 proceeds to the process in Step S15. Meanwhile, if the pause-request controller 22 determines that the Ethernet frame is not stored in the RX buffer unit 12 (Step S14: No), the pause-request controller 22 returns to the process in Step S11.

At Step S15, the SFM unit 14 reads out the Ethernet frame from the RX buffer unit 12, performs multiple mapping of the Ethernet frame on a predetermined SONET frame, then transmits the resulting data to the second external apparatus 4 at a predetermined transmission speed (Step S15).

The pause-request controller 22 monitors the amount of data stored in the RX buffer unit 12, and determines whether the amount of data has reached the pause-frame-transmission-start threshold value 12a (Step S16). If the pause-request controller 22 determines that the amount of data stored in the RX buffer unit 12 has not reached the pause-frame-transmission-start threshold value 12a (Step S16: No), the pause-request controller 22 returns to the process in Step S11.

Meanwhile, as the amount of transmission of the Ethernet frame from the first external apparatus 3 increases, if the pause-request controller 22 determines that the amount of data stored in the RX buffer unit 12 has reached the pause-frame-transmission-start threshold value 12a (Step S16: Yes), the pause-request controller 22 instructs the pause-frame generator 20c to generate the pause frame. In accordance with the instruction, the pause-frame generator 20c generates the pause frame (Step S17). Furthermore, if the pause-request controller 22 determines that the amount of data stored in the RX buffer unit 12 has reached the pause-frame-transmission-start threshold value 12a (Step S16: Yes), the pause-request controller 22 instructs the transmission-pause-time calculator 24 to calculate the transmission-pause-time. In accordance with the instruction, the transmission-pause-time calculator 24 calculates the transmission-pause-time (Step S18).

Then the pause-frame transmitter 20d adds the transmission-pause-time, which is calculated by the transmission-pause-time calculator 24, to the pause frame that is generated by the pause-frame generator 20c. The pause-frame transmitter 20d transmits the pause frame, to which the transmission-pause-time is added, to the first external apparatus 3 (Step S19).

Upon receiving the pause frame from the transmission apparatus 2, the first external apparatus 3 stops the transmission of the Ethernet frame to the transmission apparatus 2. Thus, in the transmission apparatus 2, reception of the Ethernet frame is interrupted for a period of the transmission-pause-time (Step S11: No). During the transmission-pause-time, the SFM unit 14 continuously transmits the data, which is read out from the RX buffer unit 12, to the second external apparatus 4 at a predetermined transmission speed (Step S14: Yes, Step S15, Step S16: No). Therefore, as the transmission-pause-time elapses, the amount of data stored in the RX buffer unit 12 is reduced from the pause-frame-transmission-start threshold value 12a to the data-transmission-restart threshold value 12b. As the transmission-pause-time elapses, the first external apparatus 3 restarts transmitting the Ethernet frame to the transmission apparatus 2. Thus, in the transmission apparatus 2, reception of the Ethernet frame is restarted (Step S11: Yes).

As described above, the transmission apparatus 2 according to the first embodiment calculates the time that is necessary for reducing the amount of data stored in the RX buffer unit 12 from the pause-frame-transmission-start threshold value 12a to the data-transmission-restart threshold value 12b, as the transmission-pause-time. The transmission apparatus 2 transmits the pause frame, to which the transmission-pause-time is added, to the first external apparatus 3. Thus, by transmitting the pause frame to the first external apparatus 3 only once, it is possible to control the pause and the start of the transmission of data from the first external apparatus 3. Therefore, compared with the conventional transmission apparatus which requires transmission of the pause frames to the external apparatus twice, the transmission apparatus of the first embodiment can reduce the load of transmitting the data from the transmission apparatus to the external apparatus. As a result, according to the first embodiment, the occurrence of the congestion in the data transmission in a direction from the transmission apparatus to the external apparatus can be reduced.

### [b] Second Embodiment

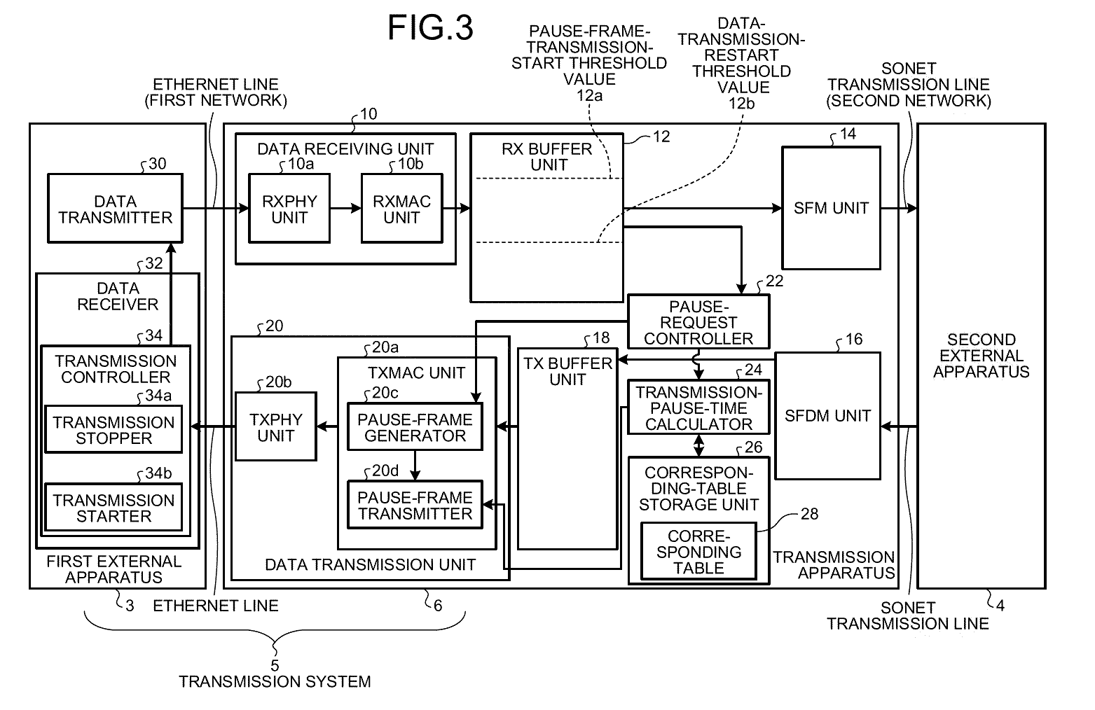

Referring to FIG. 3, configuration of a transmission system according to a second embodiment is explained. FIG. 3 is a block diagram that illustrates the configuration of a transmission system 5 according to the second embodiment. As illustrated in FIG. 3, in the transmission system 5, a transmission apparatus 6 further includes a corresponding-table storage unit 26 in addition to the configuration of the transmission apparatus 2 illustrated in FIG. 1. Except for the corresponding-table storage unit 26, the configuration of the transmission apparatus 6 is basically the same as that of the first embodiment. Therefore, in FIG. 3, to avoid duplicate explanation, parts which are the same with those in FIG. 1 are denoted with the same reference characters.

The corresponding-table storage unit 26 stores a corresponding table 28. The corresponding table 28 is a table in which the transmission speed (i.e., data rate) and the transmission-pause-time are associated with each other in advance. The data rate is a transmission speed for transmitting the data read out from the RX buffer unit 12 to the second external apparatus 4 by the SFM unit 14. The transmission-pause-time is a duration during which the transmission of data from the first external apparatus 3 is stopped.

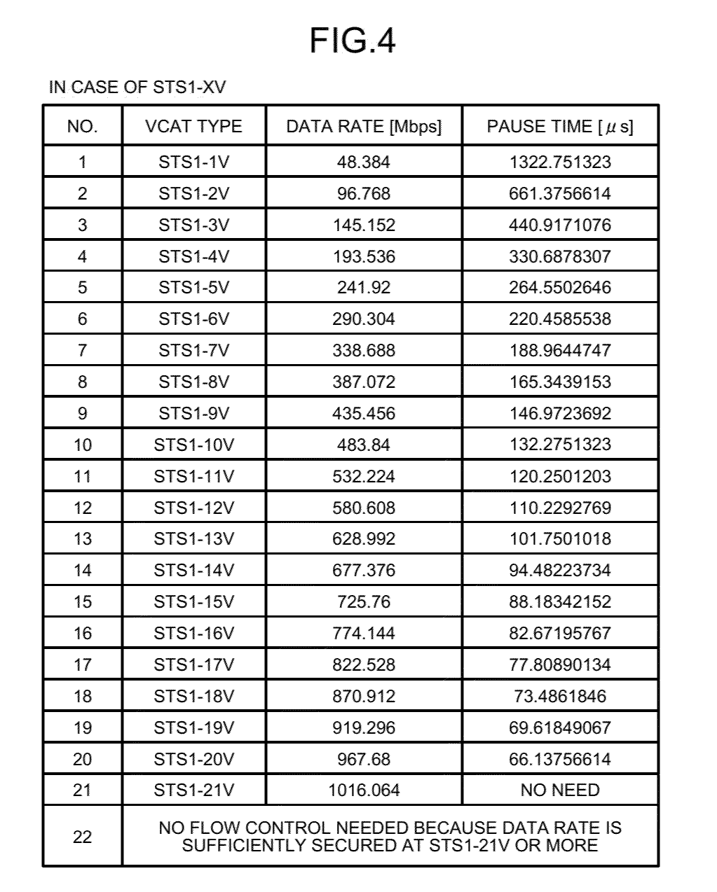

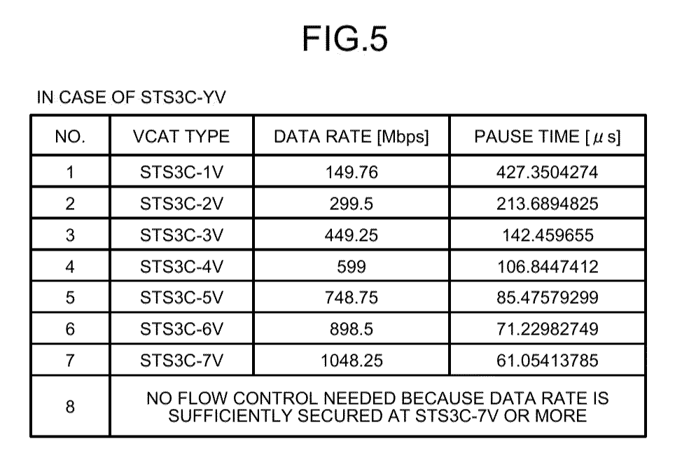

FIGS. 4 and 5 are examples of the corresponding table 28 illustrated in FIG. 3. FIG. 4 illustrates the corresponding table 28 employed when the SONET frame, on which the multiple mapping of data is performed by the SFM unit 14, is STS1-XV (X-1, 2, 3, . . . ). FIG. 5 illustrates the corresponding table 28 employed when the SONET frame, on which the multiple mapping of data is performed by the SFM unit 14, is STS3C-YV (Y=1, 2, 3, . . . ). The amount of data stored in the RX buffer unit 12 in the range from the pause-frame-transmission-start threshold value 12a to the data-transmission-restart threshold value 12b is 8 Kbyte (64 Kbit).

As illustrated in FIGS. 4 and 5, a plurality of steps of transmission speed (data rates) and a plurality of transmission-pause-times are set in the corresponding table 28. The transmission speed stored in the corresponding table 28 is a transmission speed for transmitting the data, read out from the RX-buffer-unit 12 by the SFM unit 14, to the second external apparatus 4. The transmission-pause-times stored in the corresponding table 28 corresponds to the data rates. For example, assume that the data read out from the RX buffer unit 12 by the SFM unit 14 is mapped on STS3C-2V. Because the data rate of STS3C-2V is 299.5 Mbps, the transmission-pause-time corresponding thereto is 214 μm. Thus, appropriate transmission-pause-time previously obtained is set in the corresponding table 28 in association with the data rate of the SFM unit 14.

Upon receiving the instruction to calculate the transmission-pause-time from the pause-request controller 22, the transmission-pause-time calculator 24 refers to the corresponding table 28, and calculates the optimum transmission-pause-time that corresponds to the current data rate of the SFM unit 14.

The transmission-pause-time calculator 24 outputs the calculated transmission-pause-time to the pause-frame transmitter 20d. The pause-frame transmitter 20d outputs the pause frame, to which the transmission-pause-time is added, to the first external apparatus 3.

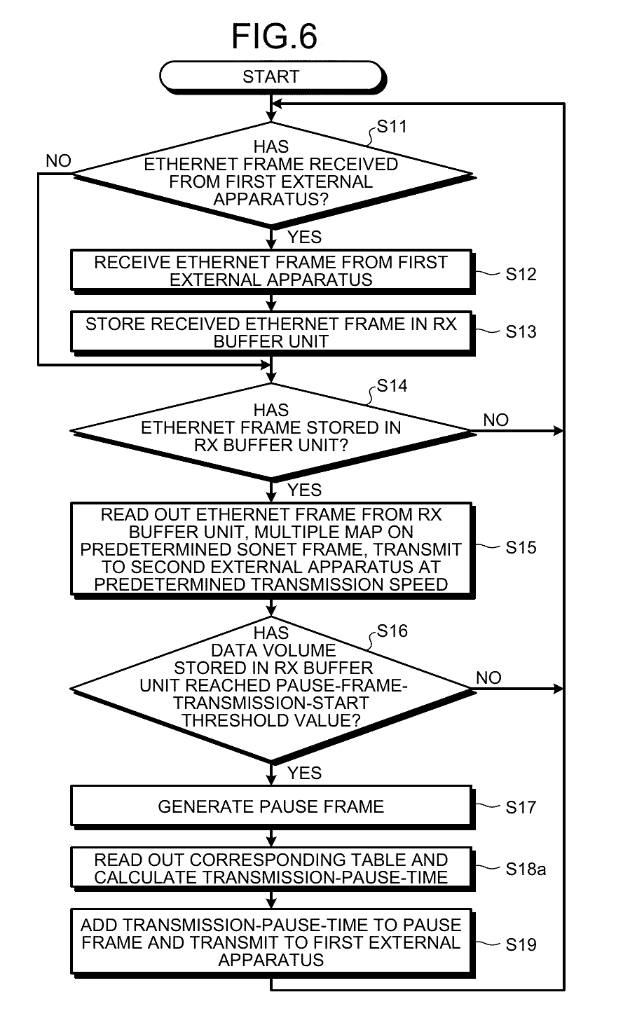

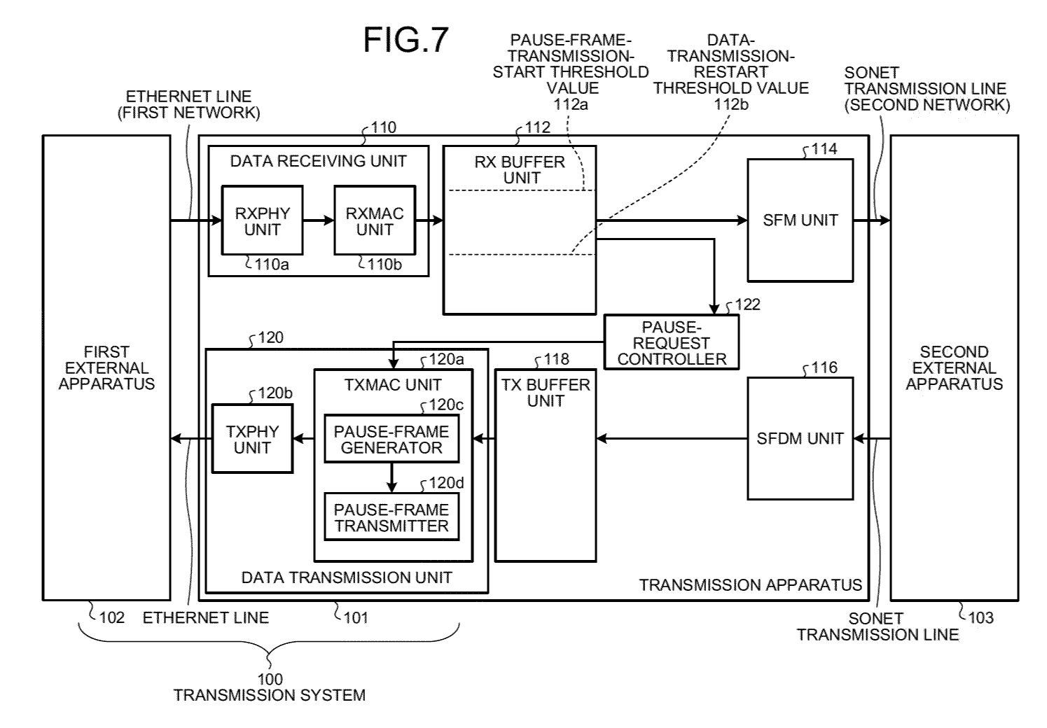

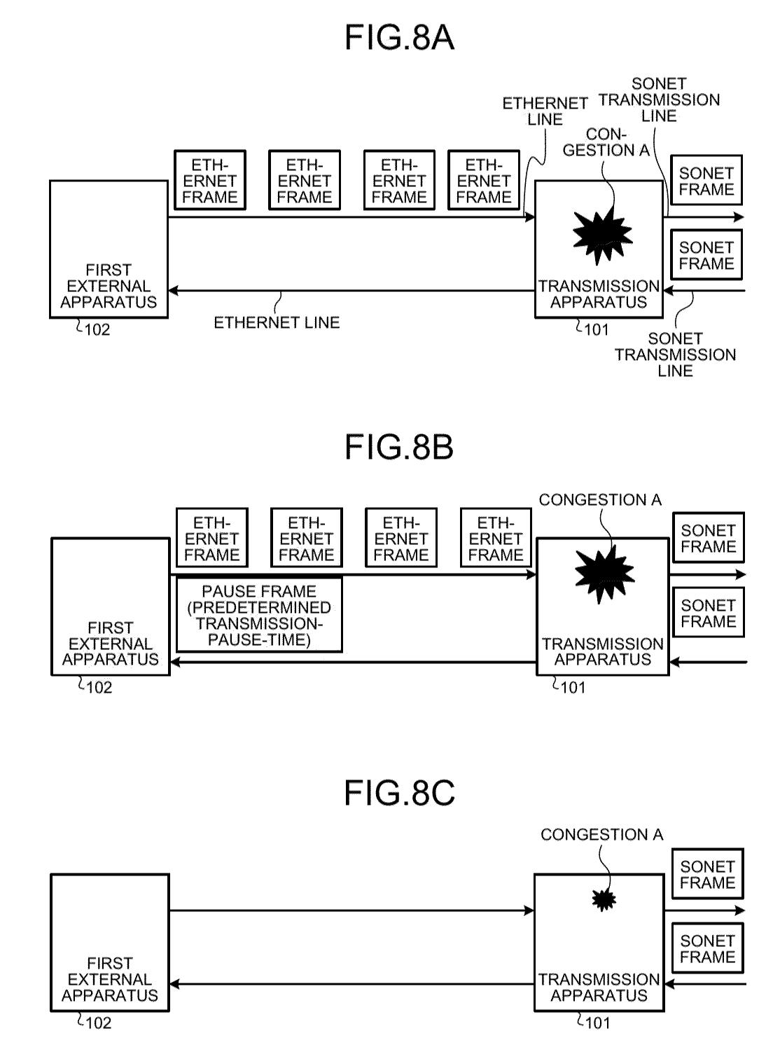

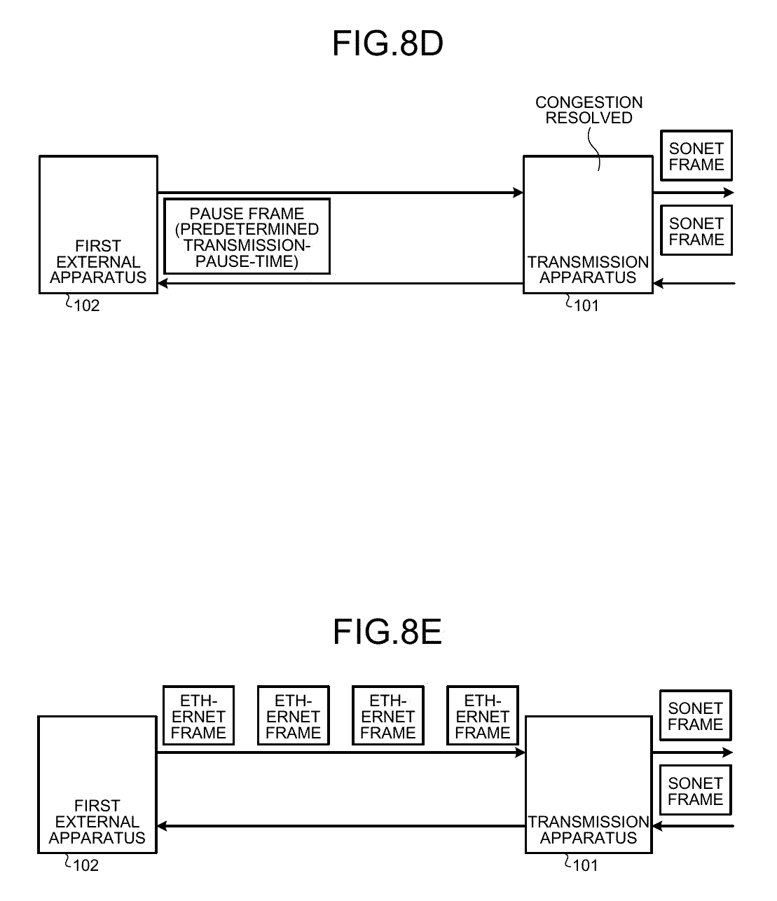

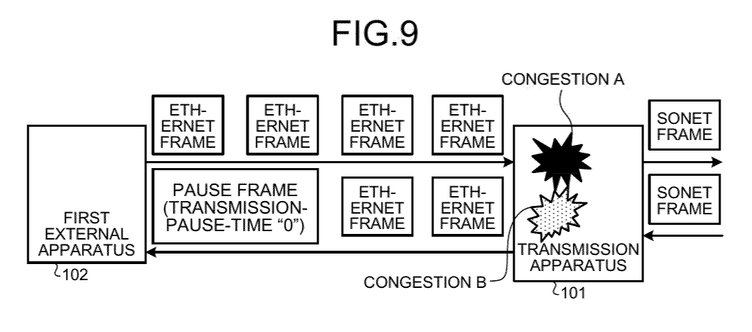

A process procedure of the data transmission process in the transmission apparatus 6 according to the second embodiment is explained. FIG. 6 is a flowchart that illustrates the process procedure of the data transmission process in the transmission apparatus 6 according to the second embodiment. The second embodiment is different from the first embodiment in that Step S18 in FIG. 2 is replaced with Step S18a in FIG. 6. Other processes (from Step S11 to Step S17, and Step S19) are basically the same with those of the first embodiment, therefore, the processes illustrated in FIG. 6, which are the same processes with those in FIG. 2 are not explained in detail.

As illustrated in FIG. 6, if the pause-request controller 22 determines that the amount of data stored in the RX buffer unit 12 has reached the pause-frame-transmission-start threshold value 12a (Step S16: Yes), the pause-request controller 22 instructs the transmission-pause-time calculator 24 to calculate the transmission-pause-time. In accordance with the instruction from the pause-request controller 22, the transmission-pause-time calculator 24 reads out the corresponding table 28 from the corresponding-table storage unit 26 and calculates the transmission-pause-time using the corresponding table 28 (Step S18a), then the pause-request controller 22 proceeds to the process in Step S19.

As described above, in the transmission apparatus 6 according to the second embodiment, the transmission-pause-time is calculated using the corresponding table 28 in which the transmission speed (data rate) of the SFM unit 14 and the corresponding transmission-pause-time are stored in advance. Thus the transmission-pause-time calculator 24 can calculate the transmission-pause-time with high efficiency. Therefore, time required for a process before the transmission of the pause frame, such as addition of the transmission-pause-time to the pause frame, can be shortened. Therefore, compared with the conventional transmission apparatus, the load for transmitting the data from the transmission apparatus to the external apparatus is further reduced. As a result, the occurrence of congestion in data transmission in the direction from the transmission apparatus to the external apparatus can be further reduced.

Advantageously, the components of the transmission apparatus of the embodiments, an expression, and any combination of the components of the transmission apparatus of the embodiments can be applied to a method, apparatus, system, computer program, recording medium, data structure, and the like, to solve the problems mentioned earlier.

According to the embodiment, data transmission from the external apparatus can be stopped and restarted by the transmission of a single pause frame, and the load for data transmission to the external apparatus is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A transmission apparatus configured to receive data from a first external apparatus via a first network, and transmit the received data to a second external apparatus via a second network, the transmission apparatus comprising:
a receiving unit that receives data from the first external apparatus;
a storage unit that stores the data received by the receiving unit;
a transmission unit that reads out the data stored in the storage unit and transmits the data to the second external apparatus at a predetermined transmission speed;
a pause-request-frame generating unit that generates the pause request frame that causes transmission of data from the first external unit to stop when an amount of data stored in the storage unit reaches a first threshold value;
a transmission-pause-time calculation unit that calculates transmission-pause-time during which the transmission of data from the first external apparatus is stopped, the transmission-pause-time being time during which the transmission unit transmits the data stored in the storage unit to the second external apparatus at the predetermined transmission speed until the amount of data stored in the storage unit is decreased from the first threshold value to a second threshold value which is smaller than the first threshold value; and
a pause-request-frame transmission unit that adds the transmission-pause-time calculated by the transmission-pause-time calculation unit to the pause request frame, and transmits the pause request frame to the first external apparatus.

2. The transmission apparatus according to claim 1, wherein the transmission-pause-time calculation unit calculates the transmission-pause-time by dividing, the amount of data stored in the storage unit in a range between the first threshold value and the second threshold value, by the predetermined transmission speed.

3. The transmission apparatus according to claim 1, further comprising
a corresponding-table storage that stores a pre-prepared corresponding table in which the predetermined transmission speed and the transmission-pause-time are stored in association with each other, wherein
the transmission-pause-time calculation unit calculates the transmission-pause-time using the corresponding table.

4. A transmission system that includes a first external apparatus, and a transmission apparatus configured to receive data from the first external apparatus via a first network, and transmit the received data to a second external apparatus via a second network,
the transmission apparatus including
a receiving unit that receives data from the first external apparatus;
a storage unit that stores the data received by the receiving unit;
a transmission unit that reads out the data stored in the storage unit and transmits the data to the second external apparatus at a predetermined transmission speed;
a pause-request-frame generating unit that generates a pause request frame that causes transmission of data from the first external apparatus to stop when an amount of data stored in the storage unit reaches a first threshold value;
a transmission-pause-time calculation unit that calculates transmission-pause-time during which the transmission of data from the first external apparatus is stopped, the transmission-pause-time being time during which the transmission unit transmits the data stored in the storage unit to the second external apparatus at the predetermined transmission speed until the amount of data stored in the storage unit is decreased from the first threshold value to a second threshold value which is smaller than the first threshold value; and
a pause-request-frame transmission unit that adds the transmission-pause-time calculated by the transmission-pause-time calculation unit to the pause request frame, and transmits the pause request frame to the first external apparatus,
the first external apparatus including
a transmission stopping unit that stops transmission of data to the transmission apparatus upon receiving the pause request frame transmitted from the transmission apparatus; and
a transmission starting unit that starts transmission of data to the transmission apparatus when the transmission-pause-time, which is added to the pause request frame, elapses.

5. A method for transmitting data received from a first external apparatus via a first network to a second external apparatus via a second network, comprising:
receiving data from the first external apparatus;
storing the data received in the receiving in a storage unit;
reading out the data stored in the storage unit and transmitting at a predetermined transmission speed to the second external apparatus;
generating a pause request frame which causes transmission of data from the first external apparatus to stop when an amount of data stored in the storage unit reaches a first threshold value;
calculating a transmission-pause-time during which the transmission of data from the first external apparatus is stopped, the transmission-pause-time being time during which the data stored in the storage unit is transmitted to the second external apparatus at the predetermined transmission speed in the transmitting until the amount of data stored in the storage unit is decreased from the first threshold value to a second threshold value which is smaller than the first threshold value; and
adding the transmission-pause-time calculated in the calculating to the pause request frame, and transmitting the pause request frame to the first external apparatus.
